(19) United States
(12) Patent Application Publication
(10) Pub. No.: US 2017/0109970 A1
(43) Pub. Date: Apr. 20, 2017

(54) AUTOMATIC IDENTIFICATION AND DATA CAPTURE PRIZE SYSTEM FOR AMUSEMENT GAME APPLICATIONS

(71) Applicant: Toccata Gaming International, LLC, Kimberly, WI (US)

(72) Inventors: Todd R. Stimac, Kimberly, WI (US); George Egonut, Kimberly, WI (US)

(21) Appl. No.: 15/299,179

(22) Filed: Oct. 20, 2016

Related U.S. Application Data
(60) Provisional application No. 62/243,817, filed on Oct. 20, 2015.

(51) Int. Cl. G07F 17/32

(52) U.S. Cl. CPC G07F 17/3248

(57) ABSTRACT

A game system having a dispenser unit to house a plurality of prizes or tokens and to dispense one or more of the prizes or tokens, a plurality of prizes or tokens disposed in the dispenser unit, an automated identification and data capture (AIDC) device associated with each prize or token and encoding information reflecting a type or value of the prize or token to which it is associated, an AIDC scanner to generate a digital signal corresponding to the information encoded on the AIDC device associated with the prize or token when the prize or token is in proximity to the AIDC scanner, and a computer processor connected to the dispenser unit and the AIDC scanner, wherein the computer processor directs the dispenser unit to dispense a prize or token in response to digital signals generated by the AIDC scanner and sent to the computer processor.

### CROSS-REFERENCE TO RELATED APPLICATIONS

Priority is hereby claimed to provisional application Ser. No. 62/243,817, filed Oct. 20, 2015, which is incorporated herein.

### BACKGROUND

This disclosure relates to a game system that tracks and manages an inventory of prizes and/or tokens and restocks its inventory based on the value of prizes won by players.

### SUMMARY OF THE INVENTION

Disclosed herein is a game system comprising at least one dispenser unit dimensioned and configured to house a plurality of prizes or tokens and to dispense one or more of the prizes or tokens. A plurality of prizes or tokens are disposed in the dispenser unit. An automated identification and data capture (AIDC) device is associated with each prize or token. The AIDC device encodes information reflecting the type or value of the prize or token to which it is associated. There is then at least one corresponding AIDC scanner dimensioned and configured to generate a digital signal corresponding to the information encoded on the AIDC device associated with the prize or token when the prize or token is in proximity to the AIDC scanner. Lastly, a computer processor is operationally connected to the dispenser unit and the AIDC scanner, wherein the computer processor directs the dispenser unit to release one or more prizes or tokens in response to digital signals generated by the AIDC scanner and sent to the computer processor.

The AIDC device is optionally a passive or active radio-frequency identification (RFID) device, and the AIDC scanner is a RFID scanner.

The game system may optionally further comprise an input/output (I/O) board operationally connected to the dispenser unit and the computer processor, wherein the I/O board is dimensioned and configured to dispense prizes or tokens from the dispenser unit in response from commands given by the computer processor.

In another version, the game system comprises a plurality of dispenser units, each dimensioned and configured to house a plurality of prizes or tokens and to dispense one or more of the prizes or tokens. A plurality of prizes or tokens are disposed in each of the plurality of dispenser units. There is then a plurality of AIDC scanners corresponding in number to the dispenser units, wherein one each of the AIDC scanners is associated with one of the dispenser units. (That is, there is one scanner per dispenser unit and vice-versa.) The computer processor directs each dispenser unit to release one or more prizes or tokens in response to digital signals generated by the associated AIDC scanner.

All references to singular characteristics or limitations of the present disclosure shall include the corresponding plural characteristic or limitation, and vice-versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The game system disclosed herein can comprise, consist of, or consist essentially of the essential elements and limitations described herein, as well as any additional or optional components, or limitations described herein.

### BRIEF DESCRIPTION OF THE DRAWINGS

FIG. 1 is a schematic diagram of a version of the game system disclosed and claimed herein.

FIG. 2 is a top plan schematic diagram of a six-player version of the game system disclosed and claimed herein.

### DETAILED DESCRIPTION

An exemplary game system includes a bin that holds winnable prizes or tokens 15 that can be exchanged for winnable prizes having predetermined values. The prizes/tokens can be embodied in any form desired (e.g., pucks, chips, coins, balls, tickets, toys, etc., or a combination thereof), and the values can be set as desired (e.g., a number of points/tickets, a monetary value, etc.). For example, the prizes can include a set of pucks, chips, or coin-like tokens with different preset or dynamically-adjustable point values (e.g., 25, 50, 100, etc.), and points can be collected and redeemed by players for particular goods (e.g., toys, food, services, admissions to events, etc.) or money. To identify, track, and manage prizes and/or tokens as they are dispensed and restocked, the system preferably uses automated identification and data capture (AIDC) technology (e.g., radio-frequency identification (RFID), bar codes, magnetic stripes, etc.) to store and communicate data used to identify a prize or token and/or its value (e.g., serial number, point value, description, etc.). For example, each prize or token can include an AIDC identifier, such as an RFID tag, indicating whether a token is worth 25, 50, 100, or other denominations of points. The term AIDC is used broadly herein and explicitly includes all methods of automatically identifying objects, collecting data about them, and entering that data directly into computer systems without human involvement or intervention, including Radio Frequency Identification (RFID), magnetic stripes, Optical Character Recognition (OCR), QR codes, smart cards, and the like. A large number of companies supply the commercial market for AIDC technologies, including Alien Technology (Morgan Hill, Calif.), Confidex (Tampere, Finland), Impinj, Inc. (Seattle, Wash.), Intermec Technologies (Seattle, Wash.), Invengo (Herndon, Va.), Metal Craft, Inc. (Mason City, Iowa), Omni-ID (Rochester, N.Y.), Smartrac (Amsterdam, The Netherlands), and many others.

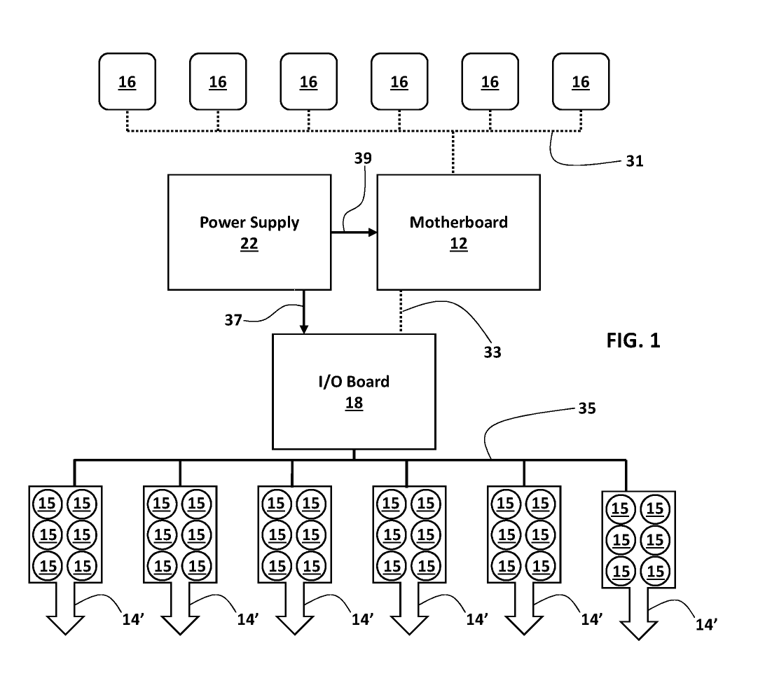

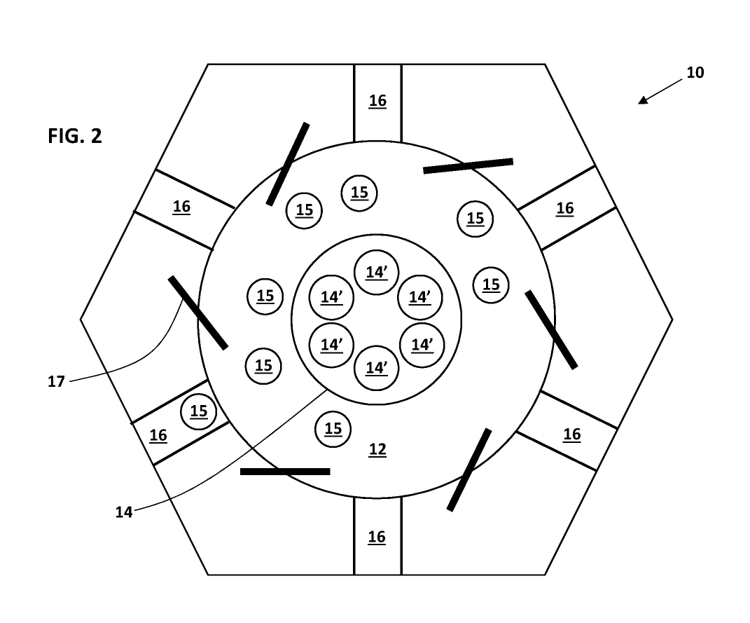

FIGS. 1 and 2 are schematic diagrams of an exemplary game according to the present disclosure. The same reference numerals are used in both figures to identify the identical elements. FIG. 1 is a schematic diagram that omits the details of the game being played. FIG. 2 is a top plan schematic diagram of a non-limiting, exemplary, rotational-type game according to the present disclosure that can accommodate up six players simultaneously. Shown FIG. 2 is game 10 having a central platform 12 onto which is deposited prizes 15 (see FIG. 1) that are vied for by the players. The game play itself is not critical to the system. As depicted in the exemplary game illustrated in FIG. 2, six player stations 17 are shown schematically as a simple arm or crane that a player uses to sweep a prize or token 15 off the platform 12 and across a scanner 16, such as an RFID scanner. Again, this is simply an exemplary version and the actual game play can take any desired form. The prizes 15 are stored and dispensed from a plurality of dispenser units 14′, housed within a centrally located dispenser 14.

As shown in FIG. 1, a plurality of AIDC tagged prizes or tokens 15, such as RFID-encapsulated prizes or tokens, are stored in a plurality of dispenser units 14′. As shown in FIG. 2, the dispenser units 14′ are disposed in a dispenser 14, situated in the center of the platform 12. Thus, the dispenser 14 is comprised of a plurality of dispenser units 14′. The dispenser units 14′ are operationally connected to a power supply 22, motherboard 20, and I/O board 18. The power supply line between the power supply 22 and the motherboard is depicted as connection 39; the power supply line between the power supply 22 and the I/O board is depicted as connection 37. All of these foregoing elements are also operationally connected to the RFID scanners 16. In this fashion, the game can track the rate and value of prizes being awarded to the player(s) and restock the platform 12 accordingly. The dispenser units 14′ are dimensioned and configured to hold the prizes/tokens 15 and to dispense the tokens in response to game play in a pre-programmed static or dynamic fashion.

The power supply 22, motherboard 20, and I/O board (input/output board) 18 are provided as illustrated in FIG. 1. The power supply 22, motherboard 20, and I/O board 18 are of conventional design and are commercially available from a host of suppliers. The power supply 22 is operationally connected to the motherboard 12 via power cord 39, and is operationally connected to the I/O board via power cord 37. The term “motherboard” is used generically herein to designate a computer processor, i.e., the main printed circuit board that contains and executes the logic that controls the play of the game and the dispensing of prizes. A host of suitable computer processors are available commercially and include, by way of example and not limitation, the AMD A8-7670K, AMD FX-8320E, and AMD Sempron 3850, available commercially from Advanced Micro Devices, Sunnyvale, Calif., and the Intel Xeon E5-2670, Intel Core i3-6100, Intel Pentium G4400, Intel Core i7-6700K, Intel Core i5-4690K and others with Intel's “Pentium” and “Core” brands of processors (Intel Corporation, Santa Clara, Calif.).

The term “I/O board” is likewise used generically herein to designate any device that transfers data to or from a motherboard and to or from a peripheral device. Every transfer is an output from one device and an input into another. As shown in FIG. 1, the motherboard 20 receives data from the scanners 16 regarding the number and value of the prizes/tokens 15 dispensed to players during the play of the game 10. This is accomplished via data links 31 between the scanners 16 and the motherboard 12. That data is then transferred to the I/O board 18, based on the pre-determined prize award rates and/or values pre-programmed into the motherboard 20. This is accomplished via data link 33 between the motherboard 12 and the I/O board 18. This results in the dispensing units 14′ to dispense additional prizes/tokens 15 onto the platform 12 to replenish the supply of prizes 15 as they are won by the players during game play. Data regarding the number of prizes dispensed and their value are fed back from the I/O board 18 to the motherboard 20 where the data are stored and can be accessed remotely for analysis (either in real time or at some later point in time). Like computer processors, I/O boards are widely available from a host of commercial suppliers, such as Omega Engineering, Inc. (Stamford, Conn.).

As shown in FIG. 2, the platform 12 can have one or more access points or player stations 17 for one or more players, with one play station for each player; six player stations 17 are shown in FIG. 2. Each player station 17 can be gated or otherwise restricted to suit the particular game such that a player is challenged to perform particular tasks or provide desired responses to cause one or more prizes or tokens 15 to be dispensed from dispenser unit 14′ to the player via the access point. For example, the platform 12 may serve as part of a “play area” or “playing field,” and each player station 17 may interface with an actuated arm that can be intermittently activated by a player to sweep or grab at a portion of the prizes/tokens 15 on the platform 12 (or an intermediate space separating the surface of the platform 12 from the player). The platform 12 is optionally moving, such as rotating, thereby spinning the prizes 15 on the platform and making the game more challenging for the players. If the one or more prizes/tokens 15 are at the right place at the right time, they can be swept or grabbed and dispensed to the player.

When a prize/token 15 is dispensed to a player, it passes over a scanner 16. As shown in FIGS. 1 and 2, a separate scanner 16 is shown for each player station 17, and thus there are six scanners 16, one for each player station. The scanner 16 is operationally connected to the motherboard 20 and the I/O board 18, which in turn is connected to the prize dispensing units 14′, as described previously. The scanner 16 is dimensioned and configured to generate a digital signal representing each prize or token sensed by the scanner and the value of the prize or token.

The player can then take the prize or token 15 from the game and redeem it for other items or otherwise “spend” it, or accumulate “points” to redeem for a larger prize, etc. The game can additionally or alternatively require a level of luck, skill, or a combination thereof, such that prizes 15 are, for example, only allowed to be dispensable at certain times or as a result of other actions or events. The probability that a prize or token 15 will be dispensable (or dispensed) can be set and adjusted as desired by programming the motherboard 20 accordingly. For example, prizes may be awarded solely on the skill of the players, or awarded in manner partially independently of actions taken by the player(s), or awarded independently of any and all actions taken by the players (i.e., games of chance).

Each player station 17 includes a scanner 16 (such as an RFID scanner) that scans each prize/token 15 as it is dispensed to the players. The particular location of the scanner 16 depends on the type of AIDC technology being used. For example, an RFID scanner should be placed such that the prizes/tokens 15 being dispensed are within a given proximity of the scanner 16 so as to register the prize/token 15 upon its release to the player. Preferably, there is at least one scanner 16 for each player station 17, such that the number of prizes/tokens 15 being dispensed and their values can be tallied for each player station. This information is useful to determine, for example, whether one of the player stations seems uncharacteristically “easy” relative to others (due to some type of systematic error in the functionality of the game). The identity and values of the prizes/tokens 15 are tabulated via a data stream generated by the scanners 16, which is transmitted to the motherboard 20 via data links 31 for storage, retrieval, and analysis, such as for bookkeeping purposes. Transmission of the data can be accomplished by any means or protocol now known or developed in the future, either via a “hard connection,” i.e., through wired connections (e.g., via an USB connection) or wirelessly (e.g., using Bluetooth or Wi-Fi). These operations connections are depicted schematically in FIG. 1 as connections 31 and 33.

Each dispenser unit 14′ may be stocked with prizes or tokens of a particular value or type, either of the same value or differing values. The motherboard 12, using information from the scanners 16, determines which prize values should be released into the platform 12 from the various dispenser units 14′ according to a pre-programmed schedule linked to the manner of the game play. When a prize/token 15 is won by a player pursuant to the game being played, the system is dimensioned and configured to activate one or more dispenser units 14′ to release one or more prizes/tokens 15 of the same, greater, or smaller values. For example, if a 100-point prize/token 15 is earned during game play, the system can replenish platform 12 by releasing another 100-point prize/token 15, or releasing a set of prizes/tokens with point values adding up to 100 (such as two 50-point prizes, four 25-point prizes, or a 50-point prize and two 25-point prizes, etc.). Alternatively, the system can instead release a combination of prizes/tokens 15 adding up to more than 100 points in aggregate (such as two 50-point prizes and two 25-point prizes), or less than 100 points (such as one 50-point prize). Or, the system can be programmed to wait until a certain number of prizes/tokens, a certain total value of prizes/tokens, or a certain combination of prizes/tokens has been dispensed before releasing additional prizes/tokens. The exact payout of the game is pre-programmed into motherboard 12 (and can be changed) by the game master.

The system is thus able to replenish the playing field 12 automatically and dynamically based on game play, helping to lower labor costs and ensure that an optimal quantity and quality of prizes are on the playing field at any one time. To stabilize or maintain the number of points being won, the system can keep players from winning too many (or too few) points in a time period (e.g., hourly, daily, weekly, etc.). For example, if no more than 1000 points should be won per hour, the system can progressively decrease the values of prizes/tokens 15 added to the platform 12 to stay within an acceptable range and lower the odds that players will win more points than the owner of the gaming system wishes to award. By adjusting how the dispense units 14 are replenished, the system can also change the gameplay experience of players (by changing, for example, how many prizes or tokens can be swept by an actuated arm), and/or the stakes of the game (by changing, for example, the values of prizes or tokens that can be won). If smaller value prizes are replaced with progressively larger value prizes, for example, players can be enticed to continue paying to play the game. The dispensing units 14′ can also be replenished based on the number of players, such that (for example) more prizes can be added if there are more players. The values of prizes can be adjusted for different players (e.g., VIP status of players can increase the winnable values), or based on how much money was paid to play the game (such that a player can pay more to increase his or her opportunity to win better prizes).

The system can have many other alternative forms and variations. For example, rather than dispensing prizes or tokens, the system can add points to a player's account. A player can start by identifying himself or herself using, for example, a magnetic ID card, a biometric reading, etc. The prizes or tokens 15 can be attained through the same game play, but rather than physically dispensing the prize or token to the player, the points can be added to the player's account.

Additionally, rather than requiring competitive or skill-based game play to win prizes, the system can be programmed to dispense one or more prizes per time period based a set of criteria or on chance. Further, one or more aspects of the system (such as game play itself) can be “virtual” or simulated play or interaction using computer graphics and images displayed on a screen, rather than physical interactions between game components and prizes/tokens 15.

The description set out above is merely of exemplary versions of the invention, and it is contemplated that numerous additions and modifications can be made, apart from combining the different features of the foregoing versions in varying ways.

What is claimed is:

1. A game system comprising:
at least one dispenser unit dimensioned and configured to house a plurality of prizes or tokens and to dispense one or more of the prizes or tokens;
a plurality of prizes or tokens disposed in the dispenser unit;
an automated identification and data capture (AIDC) device associated with each prize or token and encoding information reflecting a type or value of the prize or token to which it is associated;
at least one corresponding AIDC scanner dimensioned and configured to generate a digital signal corresponding to the information encoded on the AIDC device associated with the prize or token when the prize or token is in proximity to the AIDC scanner; and
a computer processor operationally connected to the dispenser unit and the AIDC scanner, wherein the computer processor directs the dispenser unit to release one or more prizes or tokens in response to digital signals generated by the AIDC scanner and sent to the computer processor.

2. The game system of claim 1, wherein the AIDC device is a passive radio-frequency identification (RFID) device, and the AIDC scanner is a RFID scanner.

3. The game system of claim 1, wherein the AIDC device is an active radio-frequency identification (RFID) device, and the AIDC scanner is a RFID scanner.

4. The game system of claim 1, further comprising an input/output (I/O) board operationally connected to the dispenser unit and the computer processor, wherein the I/O board is dimensioned and configured to dispense prizes or tokens from the dispenser unit in response from commands given by the computer processor.

5. The game system of claim 1, comprising:
a plurality of dispenser units, each dimensioned and configured to house a plurality of prizes or tokens and to dispense one or more of the prizes or tokens;
a plurality of prizes or tokens disposed in each of the plurality of dispenser units;
a plurality of AIDC scanners corresponding in number to the dispenser units, each of the AIDC scanners being associated with one of the dispenser units; and
wherein the computer processor directs each dispenser unit to release one or more prizes or tokens in response to digital signals generated by the associated AIDC scanner.

6. The game system of claim 5, wherein the AIDC devices are passive radio-frequency identification (RFID) devices, and the AIDC scanners are RFID scanners.

7. The game system of claim 5, wherein the AIDC devices are active radio-frequency identification (RFID) devices, and the AIDC scanners are RFID scanners.

8. The game system of claim 5, further comprising an input/output (I/O) board operationally connected to the dispenser units and the computer processor, wherein the I/O board is dimensioned and configured to dispense prizes or tokens from the dispenser units in response from commands given by the computer processor.
